(19) United States
(12) Patent Application Publication
(10) Pub. No.: US 2024/0286515 A1
(43) Pub. Date: Aug. 29, 2024

(54) Active Demand Management Systems and Methods

(71) Applicant: Rainforest Automation, Inc., Vancouver (CA)

(72) Inventors: Christopher Stanley James Tumpach, Vancouver (CA); Richard Thomas Jones, Port Coquitlam (CA)

(21) Appl. No.: 18/584,585

(22) Filed: Feb. 22, 2024

Related U.S. Application Data
(60) Provisional application No. 63/448,632, filed on Feb. 27, 2023.

(51) Int. Cl. B60L 53/63; B60L 53/67

(52) U.S. Cl. CPC B60L 53/63; B60L 53/67

(57) ABSTRACT

Active demand management system and methods are disclosed herein. An example method for active demand management includes, facilitating dynamic and adaptive control of energy consumption within a network of devices. The method involves computing a rule set based on certain conditions, assessing the current operational state of devices, and integrating user inputs and preferences. By evaluating forecasted demand against a predetermined threshold, the method generates a control strategy to sequentially deactivate devices in order of prioritized importance, ensuring demand does not surpass the set threshold. Subsequently, energy-related commands are dispatched to the devices to implement the devised plan, optimizing energy distribution and preventing overload, thereby achieving efficient demand management.

### CROSS REFERENCE TO RELATED APPLICATIONS

This non-provisional application claims the benefit and priority of U.S. Provisional Application Ser. No. 63/448,632, filed on Feb. 27, 2023, which is hereby incorporated by reference herein including all appendices, as if fully set forth herein.

This application is also related to U.S. application Ser. No. 18/530,092, filed on Dec. 5, 2023 and U.S. application Ser. No. 18/324,032, filed on May 25, 2023, which are hereby incorporated by reference herein including all appendices, as if fully set forth herein.

### FIELD OF TECHNOLOGY

The present disclosure pertains to the field of energy management systems, specifically to software-based active demand management systems and methods for optimizing energy consumption and distribution within networked environments. This includes, but is not limited to, residential, commercial, and industrial settings where dynamic control of behind-the-meter energy resources is essential for enhancing energy efficiency, ensuring compliance with electrical codes, and responding adaptively to both external grid demands and internal consumption patterns without necessitating physical infrastructure upgrades.

### BRIEF DESCRIPTION OF THE DRAWINGS

Exemplary embodiments are illustrated by way of example and not limited by the figures of the accompanying drawings, in which references indicate similar elements.

FIG. 1 illustrates the architecture of an active demand management system including a cloud-based management platform and its interaction with a premises' electric grid and smart devices.

FIG. 2 depicts a flowchart for coordinating air conditioning and electric vehicle charging based on temperature thresholds and demand management.

FIG. 3 is a graph that illustrates a summer use case scenario where an active demand management system balances electric vehicle charging with home cooling needs against a set demand threshold.

FIG. 4 is a graph that illustrates the scenario of managing the energy demand with only an electric vehicle charger available for control, focusing on soft-threshold response comparison.

FIG. 5 is a graph that illustrates the ADM method's performance against a soft-threshold response in avoiding hard breaker trips during EV charging sessions.

FIG. 6 is a graph that illustrates the total time each method (ADM and STR) spends over the soft-threshold demand during electric vehicle charging sessions.

FIG. 7 is a graph that illustrates the continuous duration that each method exceeds the soft-threshold demand during electric vehicle charging.

FIG. 8 is a graph that illustrates median continuous time spent over the soft threshold.

FIG. 9 is a graph that compares the effectiveness of the ADM and STR methods in delivering the requested electric vehicle charge within a session.

FIG. 10 is a graph that illustrates the cost efficiency of the ADM versus STR methods per kilowatt-hour of energy delivered to electric vehicles.

FIG. 11 graphically represents the power management strategy for two electric vehicles under a single meter, showing demand and state of charge over time.

FIG. 12 displays a strategy for multi-load synchronization avoidance between two homes, showcasing the management of power and internal temperature for electric vehicle charging and air conditioning.

FIG. 13 illustrates a strategy to prevent neighborhood infrastructure upgrades by managing load demands from various home appliances, including electric vehicle chargers and water heaters.

FIG. 14 depicts a computer system within which an active demand management system could be implemented, showing the components and data flow for executing the ADM methods.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for providing active demand management. The method also includes determining one or more conditions necessary to compute a rule set; determining a current state of one or more devices; receiving user inputs and overrides, if any, via the one or more devices; determining both a forecasted demand and a demand threshold, based on the rule set, the current state of each of the one or more devices, and the user inputs and overrides; when the forecasted demand is greater than the demand threshold, generating a plan to power off the one or more networked devices, one by one, in an order from a least important device to a most important device, until the forecasted demand no longer exceeds the demand threshold; and delivering energy-related device commands for the one or more devices, based on the plan. Other embodiments of this aspect include corresponding computer systems, apparatus, and computer programs recorded on one or more computer storage devices, each configured to perform the actions of the methods.

Implementations may include one or more of the following features. The method where the one or more devices includes one or more electrical vehicles, may include calculating energy delivered to the one or more electrical vehicles. Determining the one or more conditions necessary to compute a rule set includes receiving a current temperature for a dwelling from a smart thermostat inside the dwelling. The method may include estimating and forecasting non-networked device demand properties based on historical data. The one or more devices may include an electric vehicle (EV) charger that communicates via an EV charging management protocol, modbus control capabilities, and/or a Level 1 charger on a smart plug device. The rule set may be updated to optimize energy efficiency and responsiveness to changing energy demand scenarios, ensuring compliance with energy consumption thresholds without necessitating physical infrastructure modifications. the plan to power off the one or more networked devices includes managing devices based on a hierarchy of importance determined by the rule set, where the hierarchy is influenced by user inputs, device priorities, and current state information. The method may include using a group session manager (GSM) to generate a charge schedule for an EV based on a desired amount of energy, a charger and vehicle capabilities, and a utility ideal group profile (IGP). The energy-related device commands are delivered to manage not only EV charging but also other networked devices to maintain conditions within user comfort levels, such as internal temperature controlled by a smart thermostat. The method may include integrating with a real-time smart meter to obtain real-time smart meter data to inform the demand threshold and forecasted demand calculations. The one or more devices include a smart thermostat for controlling heating and cooling, a smart hot water heater, and an energy storage system, each being managed to optimize energy usage without exceeding the demand threshold. Implementations of the described techniques may include hardware, a method or process, or computer software on a computer-accessible medium.

One general aspect includes a system for providing active demand management. The system also includes a processor; and a memory coupled to the processor, the memory for storing instructions executable by the processor to perform a method may include: determining one or more conditions necessary to compute a rule set; determining a current state of one or more devices; receiving user inputs and overrides, if any, via the one or more devices; when one or more devices may include one or more electrical vehicles (EVs), calculating energy delivered to the EVs; determining both a forecasted demand and a demand threshold, based on the rule set, the current state of each of the one or more devices, the user inputs and overrides, and the energy already delivered to the EVs, when the forecasted demand is greater than the demand threshold, generating a plan to power off the one or more networked devices one by one, in an order from least important device to most important device, until the forecasted demand no longer exceeds the demand threshold; and delivering energy-related device commands for the one or more devices, based on the generated plan. Other embodiments of this aspect include corresponding computer systems, apparatus, and computer programs recorded on one or more computer storage devices, each configured to perform the actions of the methods.

Implementations may include one or more of the following features. The system where the processor is further configured to obtain current environmental conditions from connected smart devices for computing the rule set. The memory further stores instructions for estimating and forecasting non-networked device demand properties based on historical data collected over a predefined period. The one or more devices include an EV charger capable of communication via open charge point protocol (OCCP) 1.6j or higher, and the system is configured to utilize charger and vehicle communication to optimize charging schedules. The system may include a user interface for receiving user preferences and overrides related to device priorities and comfort settings, enabling dynamic updating of the rule set based on real-time user interactions. The system may include smart meter data integration for utilizing real-time energy consumption data in determining the forecasted demand and demand threshold. The memory further stores instructions executable by the processor to manage a variety of networked devices based on energy priorities, including smart device. The system may include: a network interface device for communicating with a central management system that provides updates to the rule set and demand threshold based on local grid conditions and utility requirements; and a feedback module configured to provide users with feedback regarding a current energy management plan, including which devices are being powered off and an expected impact on energy consumption. The memory further stores instructions for integrating with a group session manager (GSM) to generate and update charging schedules for EVs based on household energy demand, charger capabilities, and utility rate structures. Implementations of the described techniques may include hardware, a method or process, or computer software on a computer-accessible medium.

### DETAILED DESCRIPTION OF EXAMPLE EMBODIMENTS

### Overview

Active demand management (ADM) systems and methods are described herein, which help to manage “behind the meter” energy resources in structures, such as homes, commercial buildings, condominiums, and the like. Demand management systems can be used for the purposes of avoiding excess demand relative to residential or commercial pricing motivations, demand response events as specified by a utility provider, and/or to manage resources behind an over-subscribed electrical panel such that electrical codes are satisfied. With increasing penetration of large loads such as electric vehicle chargers, management of these and other connected devices has become increasingly important. Traditionally, energy resources are managed by making a prediction about energy resources in the near future and addressing energy issues at a later time.

However, with the advent of intermittent and distributed energy resources such as wind and solar energy, it has become increasingly difficult to make predictions about energy resources the next day or in the short-term future. The compounded problem of unpredictable energy resources, coupled with increased energy needs from such devices such as EVs, pose many challenges. The undesirable alternative at this time is to upgrade all the infrastructure which is uneconomical and not practicable.

Thus, the objectives of an active demand management system are to be flexible, dynamically predictive, and also be both adaptive and reactive to a multitude of variables or as different inputs appear. Also, the exemplary embodiments of the ADM system described herein are designed to manage a plurality of different energy resources, such as electrical vehicles (EVs), water tanks, smart thermostat, and the like. The exemplary ADM system also addresses infrastructure issues where the existing infrastructure, grids, and utilities cannot maintain or keep up with the energy demands of the energy resources of the people residing in a given neighborhood or building. The adaptive ADM system dynamically addresses the energy demands, without requiring a teardown, rebuild, or an expensive and time-consuming hardware upgrade of the existing infrastructure. Thus, the exemplary ADM system is a less costly and more efficient software-based solution to the increasing energy demands of a given neighborhood, household, or structure.

### EXAMPLE EMBODIMENTS

The present disclosure encompasses an approach to the dynamic management of residential smart devices, focusing particularly on the challenges associated with electric vehicle (EV) chargers. This approach aims to prevent the aggregate demand of a household, building, or electrical panel from surpassing set capacity limits. Traditional demand management solutions in the market often rely on rigid and simplistic rules for curtailing EV charging, a method that not only risks exceeding the rated capacity but also overlooks the nuanced demand patterns of a residence. These conventional methods lack the foresight to mitigate sudden increases in demand from unmonitored devices and offer scant guarantees for fulfilling EV charging requirements due to their narrow focus on EV charging control.

In some embodiments, the present method is adaptable to user interactions and feedback from other devices, such as smart devices. This adaptability enables the system to dynamically reprioritize devices based on current needs and conditions. Unlike static systems, this method can adjust device priorities in real-time, ensuring that energy distribution aligns with immediate household demands and preferences. This flexibility extends beyond EV chargers to encompass all smart devices within a household, thereby maintaining ambient conditions-like temperature—that align with the user's comfort levels, illustrating a comprehensive approach to smart home management.

Furthermore, the systems and methods exhibit an enhanced ability to anticipate and strategize around household electricity consumption patterns. By analyzing historical usage data and identifying trends, the systems and methods can forecast future demand and adjust management strategies accordingly. This predictive capability ensures that energy is distributed efficiently across devices, reducing the likelihood of exceeding capacity limits while also catering to the household's energy needs. Such anticipation supports more informed decision-making in energy distribution, contributing to a more balanced and efficient home energy management system.

The incorporation of real-time smart meter data into the demand management process enables the system to respond to current energy usage with minimal hardware dependencies. This feature allows for a more granular and immediate adjustment to the energy management strategy, reflecting current consumption rates and utility supply conditions. The ability to integrate this data seamlessly into an ADM system's operations enhances its responsiveness to fluctuating energy demands, ensuring that management decisions are grounded in up-to-the-minute information.

Lastly, the ADM's compatibility with managed charging solutions emphasizes its utility in ensuring that EVs achieve the desired charge level within the required timeframe, barring circumstances where it is technically unfeasible. This capability addresses one of the critical limitations of existing demand management systems by providing a more reliable and user-centric approach to EV charging. It not only ensures that EVs are adequately charged according to user schedules and needs but also integrates this functionality within a broader ecosystem of smart device management, thereby offering a holistic solution to energy demand management in modern homes.

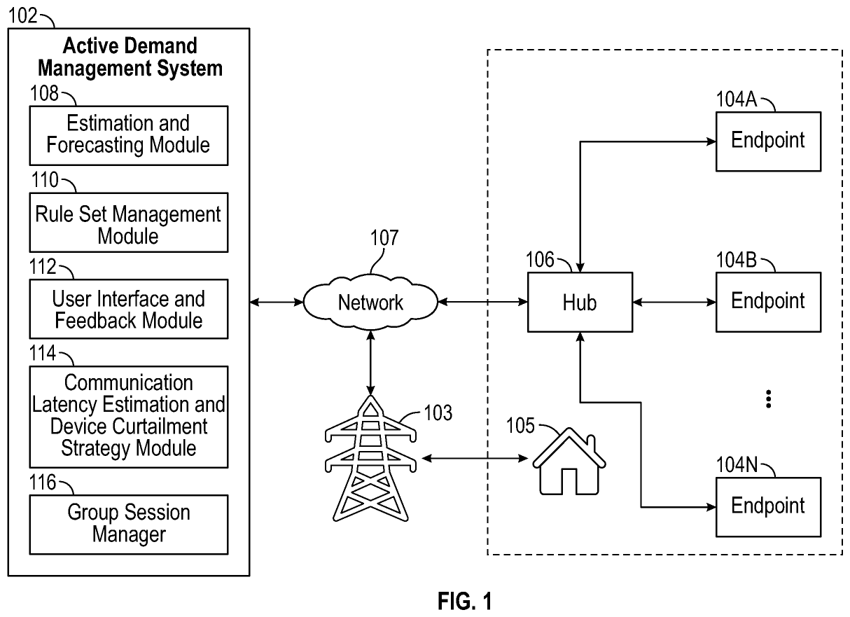

Referring now to FIG. 1, which illustrates an example architecture of the present disclosure. The architecture includes a cloud-based management platform, referred to as an active demand management system (“system 102”) that includes data analysis, forecasting, rule set adjustments, and decision-making processes. This platform facilitates the integration and coordination of various modules and services. In some instances, an electric grid or infrastructure 103 provides electricity to a premises 105.

The architecture can also include smart devices/networked devices (“endpoints 104A-104N”). These endpoints can be located at a user's premises, such as smart thermostats, lighting, EV chargers, and so forth, capable of communicating with the system 102 via any public or private network 107. Also positioned at or near the premises is a smart home device/gateway (“hub 106”) that serves as a gateway for smart devices to connect to the internet, relaying data between the home network and the system 102. To be sure, the elements inside the dotted rectangle of FIG. 1 are considered to be located at the premises 105, and monitored/controllable by the hub 106. The system 102 can provide commands to the hub 106 to cause the desired rule sets to implemented for the premises 105. In some instances, a rule set can be defined as the relative importance of various state configurations of networked loads under various external conditions.

One of the endpoints on-premises may include an EV charging infrastructure. While a physical infrastructure is on-premises, its management, including scheduling and prioritization, is handled by the system 102. This includes analyzing charger availability, vehicle charging needs, and grid capacity.

Additional details regarding the system 102 are provided in the following paragraphs. In some instances, the system 102 can include an estimation and forecasting module 108. This component utilizes historical data to anticipate future energy demand and patterns. It processes information collected from smart meters and devices to accurately forecast demand for non-networked devices.

An example method involves data analytics and machine learning algorithms to analyze short-term historical data for predicting future demand properties of non-networked devices within a household or building. The focus is on understanding patterns such as the aggregate sum of energy consumed by these devices and identifying the largest spikes in demand. That is, spikes in demand which outpace the response latency of relevant control mechanisms.

In one example, the process begins with data collection, where historical energy usage data is gathered from various non-networked devices. In some instances, historical data may not be available or used in the method. This data might include, but is not limited to, traditional appliances like water heaters, HVAC systems, and lighting fixtures that do not inherently possess smart connectivity but contribute significantly to the overall energy footprint.

The collected data undergoes preprocessing to normalize the data for analysis. This step is crucial for removing anomalies and ensuring the integrity of the data set, which in turn, enhances the accuracy of the forecasts. Following preprocessing, the system employs statistical models and machine learning algorithms to discern patterns in the historical data. This analysis aims to capture regularities in device usage that can inform future demand forecasts. For example, increased energy consumption during certain hours may correlate with routine activities, such as cooking or heating, which are predictable to some extent.

The forecasting model then extrapolates from these patterns to predict future demand scenarios. It takes into account factors such as day of the week, seasonality, and even weather conditions, which can significantly influence energy consumption patterns. The model's output includes estimates of the aggregate demand from non-networked devices over upcoming periods and predictions of potential demand spikes. These forecasts are used by the system 102 in planning energy distribution strategies. By anticipating periods of high demand, the system 102 can dynamically adjust the operation of networked devices to maintain energy consumption within the capacity limits, thereby preventing overloads and optimizing overall energy efficiency.

Additionally, the system 102 employs a feedback loop where the accuracy of the forecasts is continually assessed against actual consumption data. Discrepancies between predicted and actual demand are analyzed to refine the forecasting model, enhancing its precision over time. This continuous improvement process ensures that the system 102 remains responsive to changing usage patterns and external factors, maintaining its effectiveness in managing energy demand.

By way of example, the aggregate sum of energy consumed by non-networked devices over a given period is a metric for understanding the overall energy footprint of the premises 105. This sum represents the total energy usage by devices that are not directly controlled or monitored through smart systems but contribute to energy demand, such as refrigerators, ovens, and lighting fixtures. Exemplary forecasting of non-networked demand sources may include offsetting the household demand, which is monitored by the smarthome gateway, by the monitored networked device demand over a historical period of interest. Aforementioned correlating factors in non-networked device demand patterns can then be used to anticipate household load in the short-term future, adjusting energy management strategies accordingly.

The largest single-sample spike, on the other hand, refers to the maximum amount of energy demand observed in a short timeframe (time-based examples related to latency are disclosed infra), which could indicate the simultaneous operation of multiple high-energy-consuming devices. Identifying these spikes is useful for preventing potential overloads and ensuring that the energy distribution system can accommodate sudden increases in demand without exceeding capacity limits. For example, a family hosting a large gathering might use the oven, dishwasher, and HVAC system concurrently, leading to a significant spike in energy demand that could strain the household's electrical system.

To identify the largest single-sample spike, the system 102 analyzes the collected historical data for the highest recorded energy consumption in any given interval, such as an hour or a minute. Suppose the data shows a peak demand of five kW during dinner time on a cold winter evening when heating needs are high and the kitchen appliances are in use. This information helps the active demand management system to anticipate similar conditions in the future and plan energy distribution to mitigate the impact of such spikes, possibly by temporarily reducing the energy supplied to certain non-essential networked devices.

Incorporating these analyses into the active demand management system allows for a nuanced approach to energy distribution, ensuring that both the steady-state and peak demand conditions are managed efficiently. By understanding and planning for the aggregate sum and the largest single-sample spikes in energy demand, the system 102 can enhance operational efficiency, improve energy savings, and maintain comfort levels without compromising the infrastructure's integrity.

The system 102 can include a rule set management module 110 that is responsible for dynamically updating the prioritization rules for energy consumption. It considers a variety of factors, including user preferences, real-time energy usage, and external conditions such as grid demand, to optimize energy distribution across devices.

An example method of inferring or requesting explicit priorities for networked devices under various conditions involves a process that adapts to the dynamic nature of energy consumption and user preferences within a smart environment. This process, foundational to creating and adjusting a rule set, ensures that energy distribution is optimized across all connected devices, prioritizing them based on a variety of criteria to maintain efficiency and meet user needs.

The inference of device priorities begins with the analysis of historical usage data and real-time conditions. The system 102 leverages algorithms to detect patterns in how devices are used throughout the day and in response to specific conditions, such as weather changes or occupancy levels. For instance, on a hot day, the system might infer that the air conditioning unit has a higher priority than other devices to ensure a comfortable indoor environment. Similarly, during periods of low occupancy, entertainment devices might be assigned lower priorities compared to security systems.

An example of this inference process could involve a smart home where the family's routine shows increased use of kitchen appliances in the early evenings. The system learns to prioritize these appliances during this time to support meal preparation, while perhaps deprioritizing other non-essential devices, like a pool pump, to manage overall energy consumption within the household's capacity limits.

Besides inferring priorities from patterns and conditions, the system 102 also allows users to explicitly set or request priorities for their devices. This feature accommodates personal preferences and special requirements, granting users control over how their devices are managed by the system. Users can interact with the system through a user interface to set these preferences, which are then integrated into the rule set.

For example, a user might specify that charging their electric vehicle overnight is a top priority to ensure readiness for use the next day. The system 102 incorporates this priority into the rule set, ensuring that the EV charger receives priority over other devices during the night, even if this deviates from inferred priorities based on historical data.

The rule set is not static; it dynamically adjusts to reflect changes in device usage, external conditions, and user inputs-just to name a few. This adaptability is used to respond to unforeseen changes or emergencies, such as a heatwave necessitating higher priority for cooling systems or a power outage prompting a temporary reevaluation of device priorities to conserve backup power.

An instance of dynamic adjustment might occur during a party at home, where the sound system and outdoor lighting become temporarily critical. Users can adjust the rule set to reflect these priorities, and once the event is over, the system 102 can revert to standard priorities or adapt based on new user inputs and conditions.

A feedback loop is used in refining the inference and prioritization process. The system 102 continuously monitors the outcomes of its rule set adjustments, learning from any mismatches between predicted device importance and actual user satisfaction or energy efficiency outcomes. One primary determinant would be determined by querying whether the user modified the operating state of any networked devices. This feedback is analyzed to improve the accuracy of inferred priorities and the responsiveness of the system to user requests, ensuring that the rule set remains aligned with the evolving needs and preferences of the household or facility.

The system 102 includes a user interface and feedback module 112 that provides users with access through web browsers or mobile applications. This interface delivers insights into energy management decisions and permits users to input overrides or set preferences, enhancing the system's adaptability and user engagement. While device-level monitoring is enabled, the aggregation and analysis of data occur within the system 102 or at the hub 105. This configuration allows for the implementation of advanced algorithms designed to fine-tune device operations, ensuring energy usage is optimized for both efficiency and user comfort.

The dynamic nature of the rule set accommodates for fluctuations in energy demand, availability, and user lifestyle changes. The system 102 continuously analyzes data from various sources, including real-time energy consumption, weather forecasts, occupancy sensors, and user inputs, to adjust device prioritization in the rule set. For example, if the system 102 detects an unseasonably warm day ahead, the system 102 may preemptively adjust the rule set to prioritize cooling devices over others, ensuring user comfort without manual intervention.

This dynamic update process also considers utility rate changes, allowing the system 102 to shift device usage to off-peak hours where possible to take advantage of lower rates, thereby saving costs. For instance, if the utility company announces a temporary rate decrease for the overnight hours, the system 102 can adjust the rule set to prioritize charging electric vehicles or running high-energy appliances like dishwashers during these hours.

Through a user-friendly interface, typically accessible via a smartphone app or web portal, users can view real-time and historical data on energy consumption, the current priorities set by the rule set, and the impact of their overrides or adjustments. This visibility allows users to understand how their actions and preferences influence energy management and costs.

Moreover, the system 102 offers users the ability to override automatic prioritizations set by the rule set. This feature ensures that the system 102 aligns with the user's immediate needs and preferences, granting them ultimate control over their devices. For instance, if a user plans to host a dinner and needs the kitchen appliances to operate at full capacity despite the system's recommendation to conserve energy during peak hours, they can manually override the system 102 to prioritize these appliances temporarily.

Consider a scenario where a family is away on vacation. The system 102 dynamically de-prioritizes most of the household appliances to conserve energy. However, a sudden cold snap is forecasted, posing a risk of freezing pipes. The system 102 sends a notification to the users via the app, suggesting an override to prioritize heating to a safe minimum level to prevent pipe damage. The users can approve this suggestion directly through the app, adjusting the rule set accordingly, even from afar.

The dynamic update mechanism is complemented by a machine learning component that learns from each override and feedback instance, refining its predictive models to better align with user preferences over time. This learning process ensures that the system becomes more intuitive and aligned with user expectations, reducing the need for manual overrides and enhancing overall system efficiency and user satisfaction.

The system 102 includes a communication latency estimation and device curtailment strategy module 114. This module can estimate the response time for commands sent across the network and determining the minimum number of devices to curtail. This ensures the largest possible EV charging state is maintained, where prioritized within the rule set, considering anticipated household, building, or panel demand properties.

A method can be used to compute the minimum number of least important devices to curtail, while maintaining the largest possible EV charging state, represents a component of the system 102 that is focused on optimizing energy efficiency and user satisfaction. This approach ensures that activities, particularly EV charging where prioritized, are minimally impacted by efforts to manage and reduce overall energy consumption within the constraints of a given household, building, or panel's demand properties, and which devices can be temporarily powered down or operated at reduced capacity to save energy without significantly impacting the user's lifestyle or the operational efficiency of a building. The system 102 categorizes devices based on their importance, which is determined by a combination of user-defined priorities in the rule set and inferred priorities based on usage patterns and external conditions.

Electric Vehicle (EV) charging often represents a significant portion of a household's energy demand but is also a critical need for EV owners. The system 102 places a high priority on maintaining the desired EV charging state to ensure vehicle readiness according to user schedules and preferences. To balance this need with the goal of reducing overall energy consumption, the system 102 calculates the energy demand forecast considering all connected devices, including the anticipated demand for EV charging.

An example method can be used to first forecast the total demand and compare it against the available capacity or desired energy consumption targets. The method then simulates various scenarios where different combinations of non-essential devices are curtailed to reduce total demand. The system 102 uses optimization algorithms to identify the combination that results in the least impact on user comfort and convenience while achieving the required energy savings. This computation considers: the energy consumption profile of each device; the priority level of each device, including the EV charger; anticipated demand based on time of day and other relevant factors; and/or user preferences and override commands.

Imagine a scenario where a household is nearing its demand limit in the evening, a peak time for both domestic energy use and EV charging. The system 102 identifies that the dishwasher, pool pump, and certain lights are currently in use but are categorized as lower priority than the EV charger. By temporarily pausing the dishwasher's cycle and reducing the pool pump's operation, along with dimming non-essential lights, the system 102 can maintain the EV charging process without exceeding the demand limits established therefore.

After implementing the curtailment strategy, the system 102 monitors the actual energy savings and user responses. If the user manually overrides the decision, for instance, choosing to resume the dishwasher immediately, the system records this preference for future reference, adjusting its computational model to better align with user priorities. This feedback loop enhances the system's ability to make more informed decisions, reducing the need for user intervention over time while still respecting immediate user preferences.

### Electric Vehicle Charging Parameters

The integration of electric vehicle (EV) charging into the system 102 involves communication and control mechanisms to ensure efficient energy usage while meeting the EV owner's needs. This integration is facilitated through the use of Level 2 chargers that communicate via the Open Charge Point Protocol (OCPP) 1.6J or higher, Level 1 chargers connected through smart plug devices, and vehicles equipped with remote charge state control capabilities (these are all example endpoints). These technologies enable the system 102 to manage EV charging in a manner that is both responsive and adaptive to the broader goals of energy efficiency and demand management.

The system's ability to communicate with Level 2 and Level 1 chargers through protocols like OCPP or via modbus control capabilities allows for real-time monitoring and control of the charging process. This communication layer is used for dynamically adjusting charging rates or scheduling charging sessions to coincide with periods of low energy demand or when renewable energy production is at its peak. For instance, the system 102 can delay the start of an EV charging session to the evening when electricity rates are lower and renewable energy availability, such as wind power, may be higher.

Vehicles equipped with remote charge state control offer another layer of flexibility. Through integration with platforms like Smartcar.com, the active demand management system can directly interact with the vehicle's onboard charging system to start or stop charging, adjust charging rates, and monitor the current state of charge. This capability ensures that the vehicle is charged according to the owner's needs while optimizing for energy efficiency and cost.

Another aspect of integrating EV charging into the system 102 is the ability to estimate the response latency for commands sent to the chargers or the vehicles. Understanding this latency is used for timing the charging commands accurately, especially when optimizing the forecasting process over time to prioritize accuracy up to the worst-case latency, so that forecast can be generated far enough ahead to respond in advance of demand surges. The system 102 employs models to predict the typical latency for each communication channel and adjusts its command timing to account for these delays, ensuring that charging operations are executed as intended.

To align EV charging operations with user requirements, the system 102 incorporates a method to either infer or directly request information about the user's charging needs. This method might analyze historical charging data to predict when the EV is likely to need charging and how much charge is required to meet the user's transportation needs. Alternatively, the system can allow users to input their charging requirements directly, such as specifying a desired state of charge by a certain time or indicating preferred charging windows based on their schedule.

For example, a user planning to travel early in the morning can input a requirement for the EV to be fully charged by 7 AM. The system 102 uses this information, along with its understanding of the expected energy demand and supply conditions, to schedule the charging session optimally. It ensures the vehicle reaches the desired state of charge by the specified time, taking into account the estimated response latency for the charging commands and the current energy prices or availability of renewable energy.

In some embodiments, the system 102 can include a group session manager (“GSM 116”). Given the methods and required data in the GSM 116 can create a charge schedule at some resolution (fifteen-minute intervals for example, but this time frame is selectable) consistent with the user's requested amount of charge as well as their charger and vehicle (i.e., consistent with the amperage states supported by the charger, the max power acceptance of the vehicle, timelines for delivery of requested energy, utility Ideal Group Profile (IGP) for the associated group, etc.).

The system 102 accepts as input the desired amount of energy to be delivered in the next interval of the GSM charge schedule at the given resolution. Note that when a GSM schedule is not desired, the schedule defaults to a “naive” delivery of the energy required to charge the vehicle (“naive” here means to charge at the largest possible power state of the charger until the charge request is fulfilled). The system 102 may attempt to deliver this amount by sending appropriate commands to the charger, smart plug, or vehicle, dependent on the historical and current state of household demand, the projected demand properties consistent with the latency of device response (as set forth above with respect to latency issues), the current rule set (which is in turn dependent on external/internal conditions), as well as both the state of other networked devices, and any user intervention in the previous time-step. Throughout the GSM decision interval, the system 102 manages the charger and all networked devices, and returns to the GSM 116 the actual delivered energy, which the GSM 116 then uses to update the proposed schedule for the remainder of the user's charge request.

An example logic flow during an active EV session is discussed below. At the start of a GSM interval (e.g., every 15 minutes), the GSM 116 can generate a desired charger state sequence (CSS hereafter) for the EV at a resolution consistent with the EV command response latency (called the response interval hereafter) given the inputs. The desired CSS for a GSM interval can be represented as:

$${CSS}_{desired} = [ 3 , 3 , … , 3 , 3 ] \qquad Equation 1$$

In this example, there is one entry for every response interval (e.g., 15 seconds). This CSS corresponds to a requested energy for the interval (e.g., state three may correspond to the 6 kW state of the charger, delivering 1.5 kWh over the GSM interval). This quantity can be referred to as the interval energy request (IER).

At every response interval within a GSM interval (e.g., every 15 seconds, or other example interval) the system 102 can determine conditions necessary to compute the rule set (e.g., fetch current temperature from thermostat). The system 102 can then determine the current state of each device.

For non-EV devices, the system 102 can determine if any devices have been turned on that the system 102 has previously turned off (i.e., check for user intervention). For any such device, the system 102 can shift its priority higher in the rule set for the current conditions, allow user to override.

For any non-EV device that the system 102 has previously turned off, the system 102 can plan on turning them back on again. The system 102 can the compute the energy delivered so far to the EV during the GSM interval. Given the (possibly updated) CSS for the next response interval, the system 102 can compute the forecasted non-networked device demand and add the planned networked device demand.

Next, the system 102 can compute a demand threshold (set by the household/building/panel limit less the forecasted maximum single-sample spike in demand for the given time of day learned from historical data). If the forecasted demand exceeds this threshold, the system 102 can plan to turn off the devices from least important to most important until the threshold is no longer exceeded. Where possible, the EV should have its state decremented rather than turned off completely. The system 102 can record the non-EV networked devices that were autonomously switched off by the system 102 and send the final device commands to the smart devices.

At the end of a GSM interval, the GSM 116 can compute the energy delivered to the EV. The GSM 116 can deduct this from the requested session energy. Next, the GSM 116 generates new GSM schedule. At the end of a GSM interval, the actual CSS may look like the following:

$$\begin{matrix}E . g . , rule switch , AC priority \\ ↓ Rule switch , state increment due to under ‐ delivery relative to IER \\ ↓ \\ {CSS}_{actual} = [ 3 , 2 , 2 , 0 , 0 , 0 , 4 , 4 , 4 , 4 , 4 , 4 ] \\ ↑ \\ State decrement due to demand\end{matrix}$$

### Example Use Case (HVAC and EV Balancing)

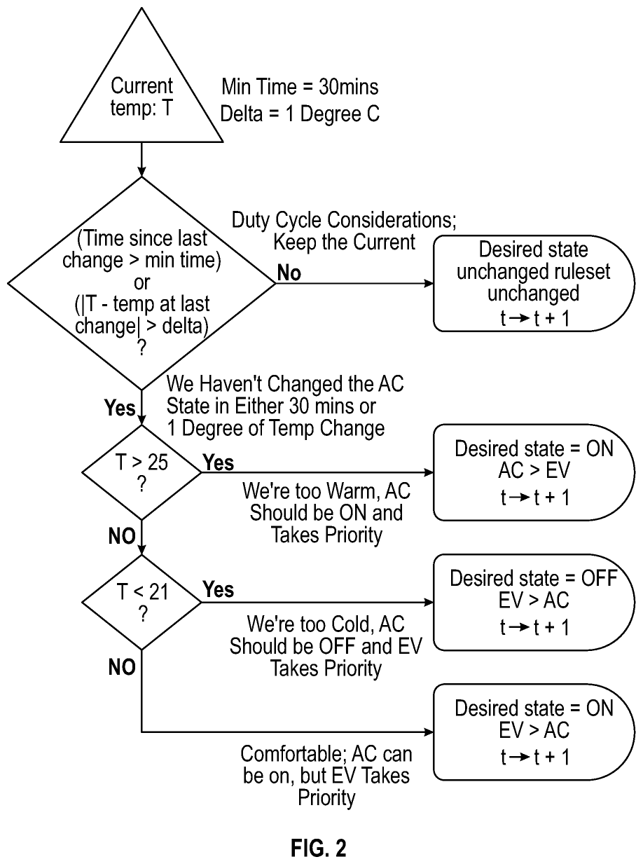

FIG. 2 illustrates a decision flow for HVAC/EV coordination where a user may set a comfort limit during active EV sessions. In more detail, the flowchart of FIG. 2 illustrates a decision-making process for an air conditioning (AC) system, with considerations for the operation of electric vehicles (EV). The flowchart begins with a measurement of the current temperature, labeled ‘Temp: T’.

The decision process includes a minimum time threshold of 30 minutes and a temperature change threshold (delta) of one degree Celsius. The system evaluates whether 30 minutes have elapsed since the previous AC state change or a temperature change greater than or equal to one degree Celsius. If neither condition is met, the system's duty cycle considerations come into play, indicating the current state should be maintained, and the ruleset remains unchanged as time progresses.

If either condition is true, implying there has been no change in the HVAC state for at least 30 minutes or a temperature change of one degree, the flowchart branches based on the current temperature: (1) if the temperature is above 25 degrees Celsius, the desired state is for the HVAC to be ON, with the HVAC taking priority over EV considerations; (2) if the temperature is below 21 degrees Celsius, the desired state is for the AC to be OFF, and EV charging takes priority; and if the temperature is between 21 and 25 degrees Celsius, the system deems it comfortable, suggesting the HVAC can be ON, but EV charging should take priority over air conditioning needs. This flowchart illustrates a system that is configured to dynamically balance energy usage between maintaining comfortable temperatures and charging electric vehicles, prioritizing either based on current conditions.

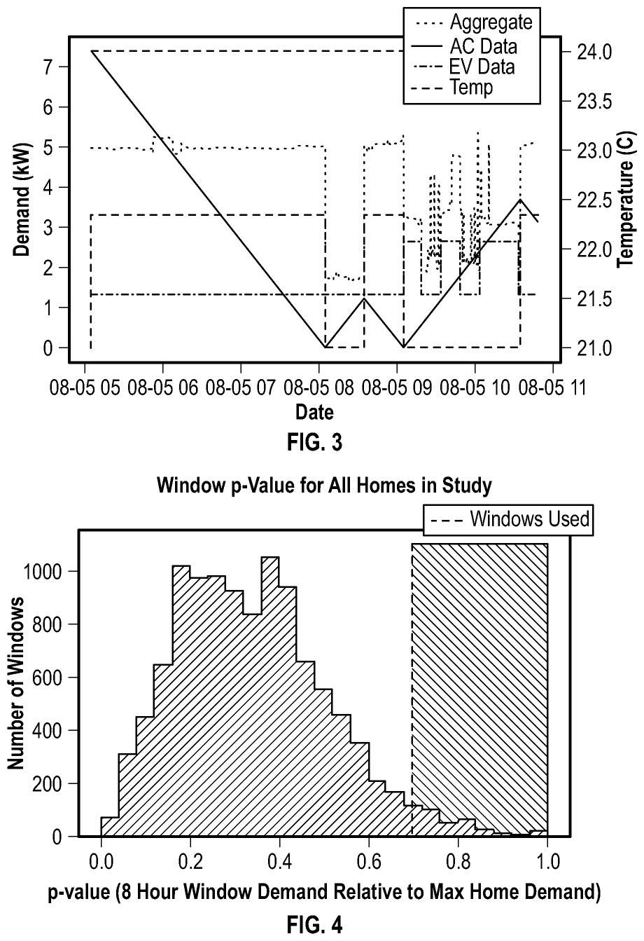

Shown in FIG. 3 is an example summer use-case wherein a user has a charge request to be filled by 11:00 am while keeping the home within specified comfort limits, and while keeping the total aggregate from exceeding the red dashed demand threshold. Here thermal dynamics have been approximated as one degree C. decrease and increase for AC active and inactive, respectively, but these quantities would be easily measured by the smart thermostat required for such a control scheme. Note also that the AC system has been approximated as a constant demand appliance. In reality, many HVAC systems are variable compressor or similar systems and can have complex demand patterns. The maximum demand state can be easily learned for such systems in an initialization stage in the absence of EV charging, which could then be used as the worst-case single state device demand.

### Example Use Case EV Only

FIG. 4 shows the most common use-case in which no additional smart devices besides a single EV are available for control. For the simulations that follow, the comparison method is what can be called a soft-threshold response (STR) method, in which the system shuts off the charger if the demand exceeds 80% of the hard demand limit (i.e., the soft-threshold). When the charger is turned off, the STR method waits until the household demand drops below this soft-threshold for 15 consecutive minutes. Both methods are initiated with the same charge schedule generated by the GSM, and both methods attempt to fulfill each IER, and receive updated (potentially unique) GSM schedules. Both methods are responding to demand samples at 8 second resolution, with (for simplicity) an additional eight second EV response delay.

In order to properly elucidate the difference between the ADM method and the comparison method, we focus on the worst-case scenario in terms of household demand relative to an EV charging session. For this, we explored 12 homes with one year of aggregate demand data and ordered them in terms of largest demand seen in two-hour windows. We divide each window by the largest overall demand of the home such that each window in the home is expressed by a number p between 0 and 1 indicating how close it is to the worst case for the home. We then select those windows above the 70th percentile for each home, and treat each as though p=1, i.e., each window corresponds to the largest possible demand for the home assuming that the home is to code (i.e., the maximum of each window is treated as the soft threshold, which is 80% of the hard breaker threshold). This p>0.7 limit ensures that each window is at least reasonable with respect to the household demand limit (i.e., large appliance activations are not wholly inconsistent with the breaker limit). In other words, we only take windows whose maximum demand is at least 70% of the maximum demand observed in the house, and we then treat each of these as though they were p=1 as explained above.

A summary of typical real p values across all homes under investigation is shown in FIG. 4. As seen, the selected windows with p>0.7 constitute a very small tail of typical household usage. Normal usage averages to around 0.2 or 0.4 of the maximum demand value observed in the household data under study. The results below should be taken with this in mind—the windows selected for study are not representative of typical household usage; this is an investigation into the worst-case scenario for demand management. In total, we selected 651 windows for study across 12 homes.

The session request being fulfilled in the below investigation is summarized by the following. A Level 2 user charging at 220 V with amperage states [0, 6, 12, 18, 24, 32]A (amps). The user requests 10 kWh of energy over a two-hour window. The user has historical interval data for a period of 30 days preceding the session. A naive session for this user (i.e. charging at 32 A until 10 kWh is delivered) would take about 1.5 hours. This leaves about 30 minutes to either suspend charging or distribute charging over the smaller amperage states. Again, this is an artificially dangerous use-case. A nearly naive charging session over a two-hour window coinciding with every appliance being active in the home is extremely unlikely to occur.

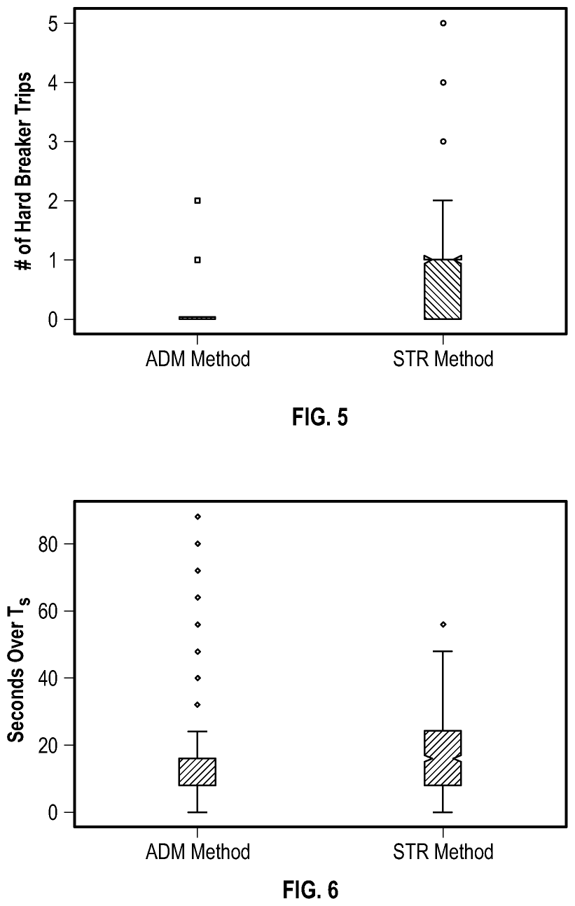

A summary of per-session metrics for comparison between the present ADM method and the STR method. The most important metric for comparison is the tendency to trip the hard breaker limit (again, set to just 25% higher than the pre-EV window maximum demand). The ADM method below shows a highly reduced hard trip risk across sessions (21% of windows for ADM as opposed to 56% for STR), with significantly fewer trips per session. Given the artificially risky nature of the windows under study, this is an appreciable difference. This is shown in FIG. 5.

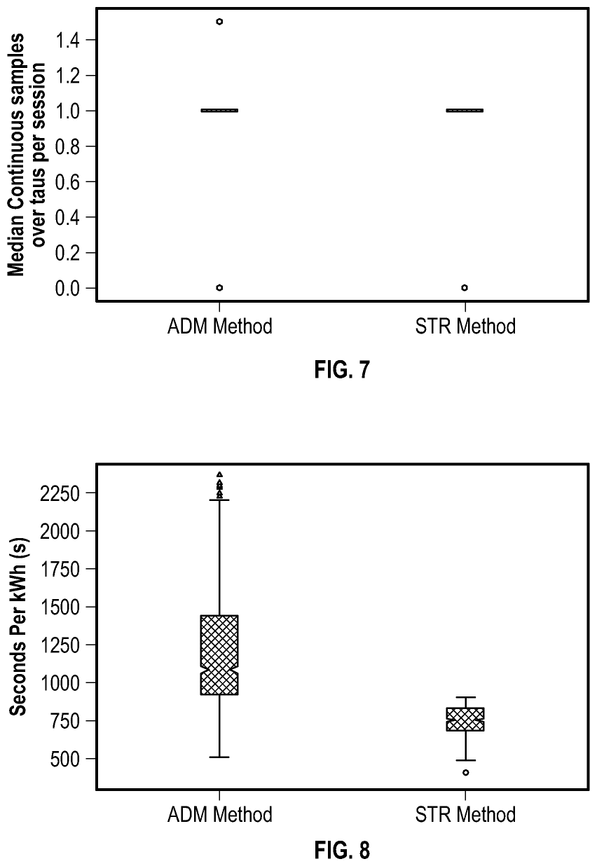

FIG. 6 shows the total time spent over the soft threshold per session. Here we see that STR method is spending a statistically significant amount of time per session over the soft-threshold compared to the ADM method. Another important metric is to see how long each method is spending continuously over the soft-threshold. i.e., are they exceeding the soft-threshold for a single eight second sample, or longer. FIG. 7 shows that both methods average going over the soft-threshold once, with some outliers in the ADM method with an additional sample spent over the threshold.

Another metric is to determine how quickly each method is charging the EV. A more careful method might take longer to deliver the same amount of energy as a less careful method. In FIG. 8, we see that the ADM method takes nearly 50% longer to deliver a kWh for the median session, with a much wider distribution over this metric. Although on the face of it this might appear a weakness of the ADM method, it points to a flexibility of the method to charge more slowly or more quickly in a dynamic fashion, whereas the STR method is less flexible and typically delivers energy at a similar rate across sessions, which, taken with the hard trip tendency shown above, is a less desirable feature.

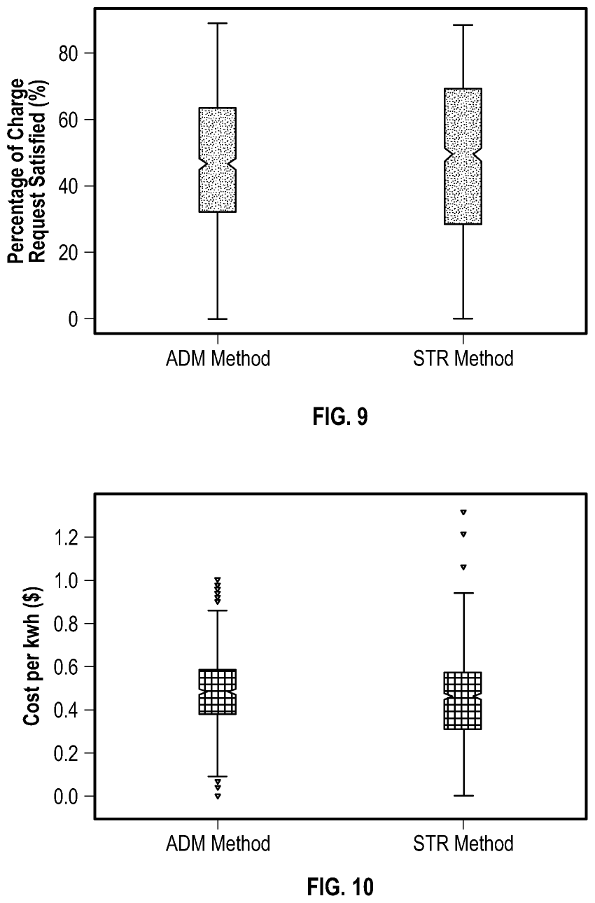

Another important metric to look at is how much of the desired 10 kWh was delivered by each method. In FIG. 9 we see that the two methods are not statistically significant in their median differences—i.e. under this sample the two are centered on the same charge percentage delivered. Again, however, the distribution of the 5th and 95th percentiles for the ADM method are tighter than the STR method. Taken with the previous plot showing a typically longer time to charge for the ADM method, this reinforces the claim that the ADM method is more flexible and careful in its delivery of energy, and is more consistent overall in what it delivers.

A somewhat less important metric for these comparisons is what each method is costing the customer for each kWh delivered shown in FIG. 10. Presumably, this has more to do with the difficulty of the window relative to the pricing plan than any intrinsic difference in methods.

Overall, this investigation showed that the ADM method by comparison to the STR method is more careful, reducing relative hard breaker trip risk by 61% across sessions. It typically takes longer to deliver the requested session energy than the STR method, but tends to deliver the same amount of energy and more consistently across sessions. It also spends less time over the soft threshold, both in terms of total time and total continuous time. Again, this is a comparison between methods over artificially difficult windows with a nearly naive session request. Over wider windows (more time to deliver the requested energy) and/or easier windows (the max demand in the session window is usually much less than 80% of the hard breaker limit), the two methods will likely perform very similarly, and have less risk of hard breaker trips and fewer issues delivering the requested energy.

To gauge the difficulty of the windows explored here, we can ask “what is the likelihood that a charge session is coincident with all appliances being active in the home? And furthermore what is the likelihood that a given home is only just up to the electrical code (i.e. the sum of all appliances is exactly 80% of the main breaker limit) ?” This is the case assumed for every window in this investigation.

Furthermore, it should be emphasized again that this is in the worst-case of only controlling an EV. The ADM method will improve relative to other methods proportional to the level of control afforded by connected devices.

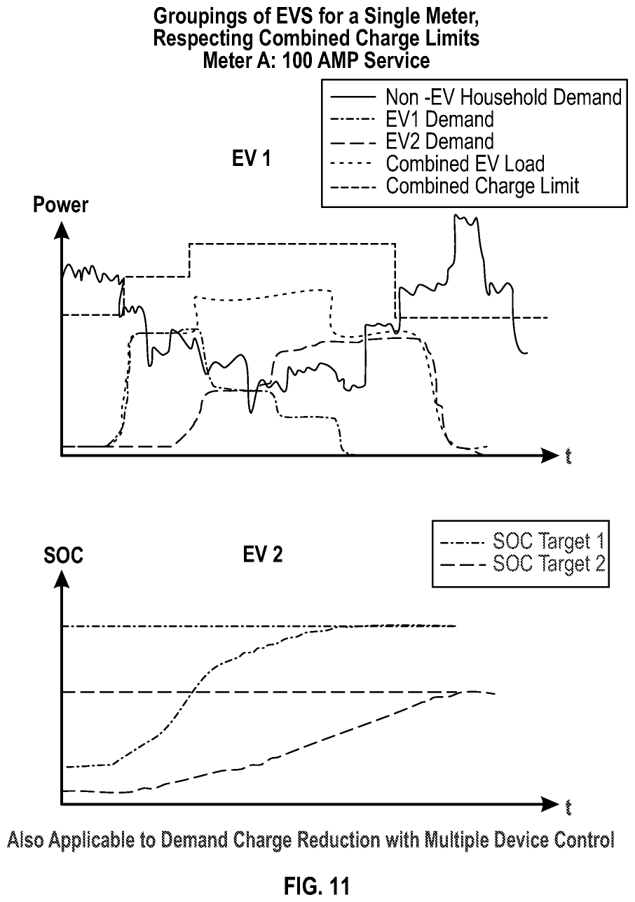

FIG. 11 is a graphical representation of the power management strategy for two electric vehicles (EV1 and EV2) being charged under a single electrical meter, referred to as “Meter A,” which has a 100-amp service limit. FIG. 11 is divided into two main sections: Power and State of Charge (SoC).

In the “Power” section, there are four lines representing different aspects of power demand over time (t): non-EV household demand, which fluctuates over time; power demand from EV1; power demand from EV2; a combined power load of both EVs, which must be managed carefully to not exceed the service limit. A combined charge limit is a threshold set to ensure the total power demand does not exceed the capacity of the meter. The goal is to manage the charging of EV1 and EV2 in such a way that the combined EV load (red dotted line) respects the combined charge limit (red dashed line). FIG. 11 shows instances where the EV demand must be adjusted to stay within the limit while accommodating the household's power needs.

The “SoC” section of FIG. 11 shows two lines indicating the state of charge over time for each EV: a first line is a target SoC for EV1, and a second line is a target SoC for EV2. Both EVs have distinct SoC targets and are charging progressively over time. The goal is to reach these targets while managing the power demand to avoid exceeding the meter's capacity.

It will be understood that the strategy is also applicable to demand charge reduction with multiple device control to reduce the costs associated with high power demands (demand charges) by intelligently controlling the charging of multiple devices (in this case, the two EVs).

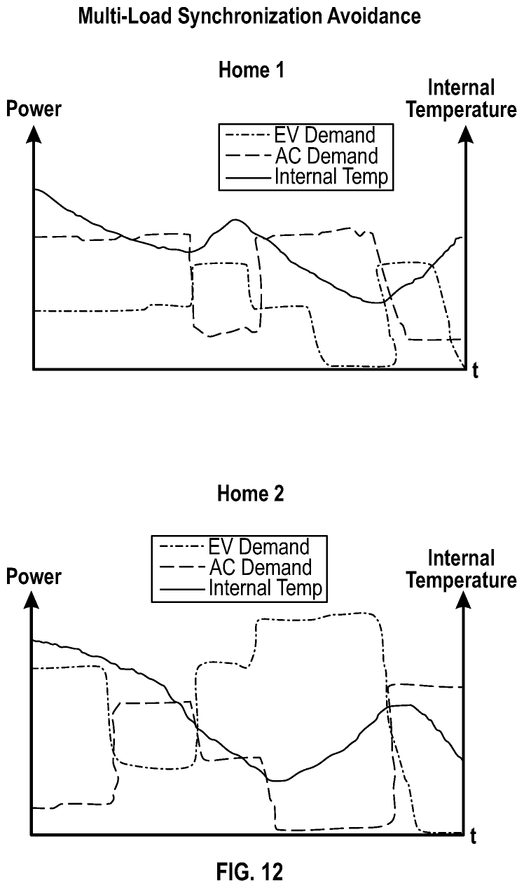

FIG. 12 is a visual representation of a multi-load synchronization avoidance strategy across two homes, labeled Home 1 and Home 2. This strategy is focused on ensuring that power demand from various loads, such as electric vehicle (EV) charging and air conditioning (AC), do not coincide in a way that could lead to excessive power consumption at the same time, which is essential for maintaining a balanced load on the electrical grid.

For both Home 1 and Home 2, three parameters are tracked over time (t): EV demand (blue line), AC demand (orange line), and internal temperature (red line). With respect to Home 1, the power graph shows the EV demand and AC demand fluctuating over time. There are periods where the EV and AC demand spikes do not overlap, suggesting that synchronization is being avoided. The internal temperature remains relatively stable, showing that the comfort level is being maintained while managing the power demands of the EV and AC.

With respect to Home 2, similarly, the power graph illustrates separate peaks for EV demand and AC demand. The internal temperature has more variation compared to Home 1, but the comfort level within the home is being considered. It's notable that the demands for EV and AC power are staggered, indicating an intentional strategy to avoid simultaneous high-power draw, an example of synchronization avoidance.

Overall, FIG. 12 conveys a smart energy management system that staggers high-energy-consuming tasks such as EV charging and air conditioning. By preventing these high-demand loads from peaking at the same time, the system can avoid large spikes in power usage, which could lead to higher utility costs or strain the electrical infrastructure. The internal temperature lines illustrate that this load management is being achieved without compromising the thermal comfort inside the homes. This approach is particularly relevant for energy efficiency measures and demand response programs.

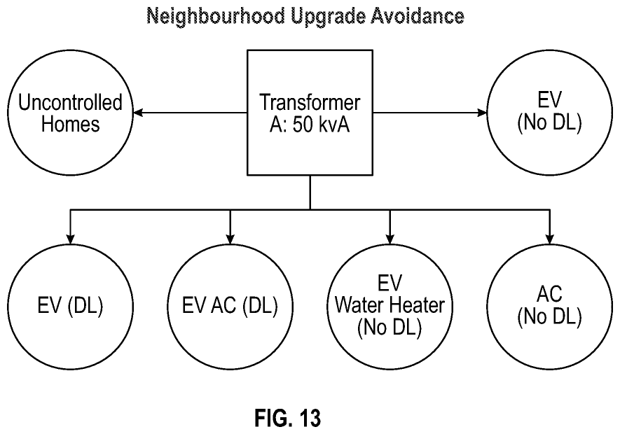

FIG. 13 is a diagram that illustrates a concept for avoiding infrastructure upgrades in a neighborhood through strategic load management, specifically focusing on a transformer labeled “Transformer A: 50 kVA”. This concept is part of a demand-response system aimed at balancing the electrical load within a local grid.

The diagram shows four types of homes and labeled with the primary controllable loads: uncontrolled homes are homes that do not have any demand control systems in place. EV (Electric Vehicle) only homes have EV charging as the controllable load. This could be a local EV charger as well, not located in a home; EV+Water Heater are homes have both EV charging and water heating as controllable loads; and AC (Air Conditioning) only homes have air conditioning as the controllable load.

The ADM system can manage the electrical demand from these homes in a way that avoids overloading Transformer A. In a first scenario, if all homes are controlled only for EV charging without internal demand limits, a group-managed charging solution can be employed. In another scenario, if some homes have internal demand limits and other connected & deferrable loads, these can be coordinated for optimal usage.

In a demand-response event dispatched to a transformer, the solution can coordinate deferrable loads to meet user comfort requirements while also managing EV charging needs.

Therefore, the ADM system provides a dynamic demand-response that not only prevents the need for costly infrastructure upgrades but also benefits consumers through cost savings and utilities through more efficient load management. The overall objective of the strategy depicted in FIG. 13 is to achieve neighborhood upgrade avoidance by coordinating and controlling the energy usage of various household appliances and systems, in turn, helping to manage the demand placed on the local transformer.

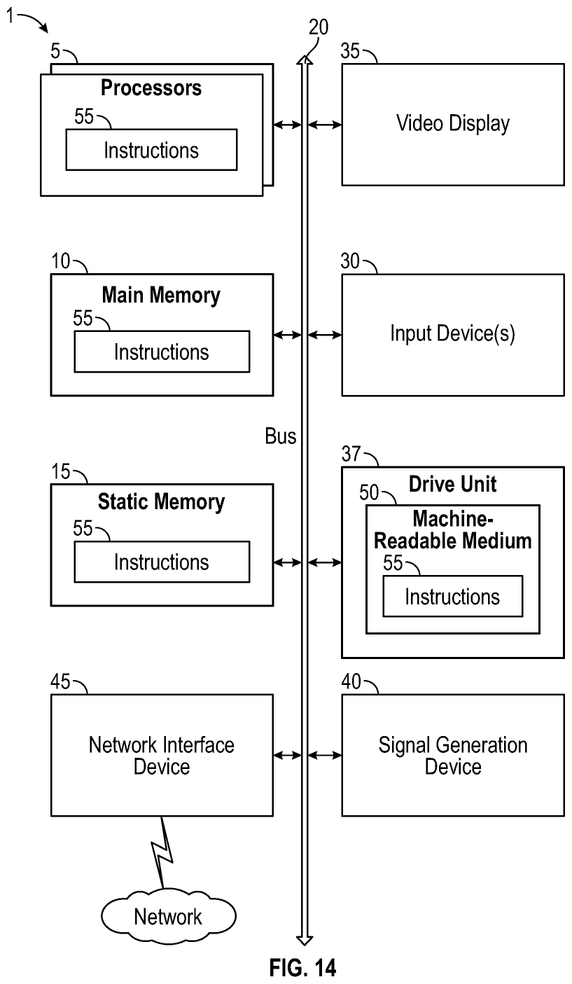

FIG. 14 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for providing active demand management, comprising:
determining one or more conditions necessary to compute a rule set;
determining a current state of one or more devices;
receiving user inputs and overrides, if any, via the one or more devices;
determining both a forecasted demand and a demand threshold, based on the rule set, the current state of each of the one or more devices, and the user inputs and overrides;
when the forecasted demand is greater than the demand threshold, generating a plan to power off the one or more networked devices, in an order from a least important device to a most important device, until the forecasted demand no longer exceeds the demand threshold; and
delivering energy-related device commands for the one or more devices, based on the plan.

2. The method of claim 1, wherein the one or more devices includes one or more electrical vehicles, further comprising calculating energy delivered to the one or more electrical vehicles.

3. The method of claim 1, wherein determining the one or more conditions necessary to compute a rule set includes receiving a current temperature for a dwelling from a smart thermostat inside the dwelling.

4. The method of claim 1, further comprising estimating and forecasting non-networked device demand properties based on historical data.

5. The method of claim 1, wherein the one or more devices include an electric vehicle (EV) charger that communicates via an EV charging management protocol, modbus control capabilities, and/or a Level 1 charger on a smart plug device.

6. The method of claim 1, further comprising dynamically adjusting the rule set for prioritizing energy distribution among networked devices based on real-time analysis of external conditions, including grid demand and renewable energy source availability, and internal conditions, including user-defined preferences and device operational states, wherein the rule set is updated to optimize energy efficiency and responsiveness to changing energy demand scenarios, ensuring compliance with energy consumption thresholds without necessitating physical infrastructure modifications.

7. The method of claim 1, wherein the plan to power off the one or more networked devices includes managing devices based on a hierarchy of importance determined by the rule set, where the hierarchy is influenced by user inputs, device priorities, and current state information.

8. The method of claim 1, further comprising using a Group Session Manager (GSM) to generate a charge schedule for an EV based on a desired amount of energy, a charger and vehicle capabilities, and a utility Ideal Group Profile (IGP).

9. The method of claim 1, wherein the energy-related device commands are delivered to manage not only EV charging but also other networked devices to maintain conditions within user comfort levels, such as internal temperature controlled by a smart thermostat.

10. The method of claim 1, further comprising integrating with a real-time smart meter to obtain real-time smart meter data to inform the demand threshold and forecasted demand calculations.

11. The method of claim 1, wherein the one or more devices include a smart thermostat for controlling heating and cooling, a smart hot water heater, and an energy storage system, each being managed to optimize energy usage without exceeding the demand threshold.

12. A system for providing active demand management, comprising:
a processor; and
a memory coupled to the processor, the memory for storing instructions executable by the processor to perform a method comprising:
determining one or more conditions necessary to compute a rule set;
determining a current state of one or more devices;
receiving user inputs and overrides, if any, via the one or more devices;
when one or more devices comprise one or more electrical vehicles (EVs), calculating energy delivered to the EVs;
determining both a forecasted demand and a demand threshold, based on the rule set, the current state of each of the one or more devices, the user inputs and overrides, and the energy already delivered to the EVs,
when the forecasted demand is greater than the demand threshold, generating a plan to power off the one or more networked devices one by one, in an order from least important device to most important device, until the forecasted demand no longer exceeds the demand threshold; and
delivering energy-related device commands for the one or more devices, based on the generated plan.

13. The system of claim 12, wherein the processor is further configured to obtain current environmental conditions from connected smart devices for computing the rule set.

14. The system of claim 12, wherein the memory further stores instructions for estimating and forecasting non-networked device demand properties based on historical data collected over a predefined period.

15. The system of claim 12, wherein the one or more devices include an EV charger capable of communication via Open Charge Point Protocol (OCPP) 1.6 J or higher, and the system is configured to utilize charger and vehicle communication to optimize charging schedules.

16. The system of claim 12, further comprising a user interface for receiving user preferences and overrides related to device priorities and comfort settings, enabling dynamic updating of the rule set based on real-time user interactions.

17. The system of claim 12, further comprising smart meter data integration for utilizing real-time energy consumption data in determining the forecasted demand and demand threshold.

18. The system of claim 12, wherein the memory further stores instructions executable by the processor to manage a variety of networked devices based on energy priorities, including smart device.

19. The system of claim 12, further comprising:
a network interface device for communicating with a central management system that provides updates to the rule set and demand threshold based on local grid conditions and utility requirements; and
a feedback module configured to provide users with feedback regarding a current energy management plan, including which devices are being powered off and an expected impact on energy consumption.

20. The system of claim 12, wherein the memory further stores instructions for integrating with a Group Session Manager (GSM) to generate and update charging schedules for EVs based on household energy demand, charger capabilities, and utility rate structures.
